(19) United States
(12) Patent Application Publication
(10) Pub. No.: US 2010/0083455 A1
(43) Pub. Date: Apr. 8, 2010

(54) Tool for holding small parts

(76) Inventors: Christian Wolfram Hahn, Prospect, KY (US); John Warren Moers, Fallbrook, CA (US)

Correspondence Address: Law Offices of Stanley A. Becker, 18716 Avenida Cordillera, San Diego, CA, 92128, US

(21) Appl. No.: 12/287,439

(22) Filed: Oct. 8, 2008

(51) Int. Cl. B05C 21/00

(52) U.S. Cl. 15/257.01

(57) ABSTRACT

A tool for holding small parts and for immobilizing the parts during cleaning or other treatment with a fluid. The tool includes first and second porous members which encompass the part. At least one of the first and second members is deformable to partially conform to the part. The tool has elements for holding or securing the first and second members together during cleaning. The tool may also have a handle connected to the first and second porous members. The handle may be spring biased so that the first and second members are normally held together to enclose a part. The handle can be manipulated to move the first and second members apart when it is desired to insert or remove a part from between them.

### BACKGROUND OF THE INVENTION

1. Field of the Invention

The present invention relates to a tool or instrument for holding small or delicate parts during cleaning or other treatment with a fluid. More specifically, the present invention relates to a tool for substantially immobilizing a part while it is subjected to a fluid stream or bath for cleaning or other treatment. The part is held in such a way that the entire part can be cleaned or treated without any substantial portion of it being masked by the tool.

2. Description of Related Art

U.S. Pat. No. 7,213,605 discloses a tool for holding jewelry articles during cleaning. The tool has a spring handle that opens two hemispherical shaped baskets. A spring clip inside one of the baskets holds the article to be cleaned. The spring clip masks that portion of the article which is beneath the clip.

The foregoing prior art does not suggest a tool for holding a part to be cleaned so that it is substantially immobilized without any portion of the tool masking the part to be cleaned.

### SUMMARY OF THE INVENTION

Many small and/ or delicate parts must be cleaned or otherwise treated before they can be used. For example, and without limitation, dental restorations have to be cleaned before they are fitted into a patient. Such parts are somewhat delicate and have to be held carefully during cleaning. The present invention provides a tool for allowing a dentist or his assistant to hold a restoration while in the process of washing with acid, water or other fluid in the process of cleaning. The tool is designed to allow substantially the entire restoration to be immobilized and cleaned without any substantial part being masked during the cleaning process.

The invention consists of a tool having a first porous member, such as a mesh, for holding a part, and a second porous member fitting over the first member in close proximity thereto, for substantially immobilizing the part therebetween. One or both of the first and second porous members is deformable by the part when it is placed between them. The deformable porous member partially conforms to the part to immobilize it against the other porous member, thus allowing the part to be placed into a stream of fluid or a bath for cleaning or other treatment without damaging the part. The porosity of the porous members has between 20% and 80% open area to allow the fluid to pass through and wash over the part. The elements of the porous member, such as the mesh, are flexible and fine enough to allow the entire part to be cleaned without any portion of it being masked from the cleaning or treatment fluid.

The tool may have a handle if desired. The tool may also have facilities for locking the first and second member together during the cleaning process. The shape of the first and second members is preferably round, but square or other shapes could be utilized as well.

In one embodiment of the invention, the first and second members are rings having a flexible mesh fitted therein. The mesh of one or both rings is deformable to partially conform to the part. The first or bottom ring has one or more openings in the side therof. The second or top ring has one or more complementary protrusions adapted to fit into the openings of the first ring to hold the two rings together with a part in between.

In another embodiment of the invention the two rings are hinged to keep them together to allow a part to be placed between them.

Many alternative embodiments of the invention are possible within the scope of the invention.

### BRIEF DESCRIPTION OF THE DRAWINGS

FIG. 1 shows a perspective view of one embodiment of a tool in accordance with the principles of this invention having a bottom ring and a top ring, each having mesh within the ring, with the bottom ring having a latch for securing the top ring.

FIG. 2 is a perspective view of the bottom and top rings showing more clearly one opening in the bottom ring and the protrusion on the top ring which fits into the opening of the bottom ring.

FIG. 3 is a cross sectional view taken along line 3-3 in FIG. 1 showing a part held between two porous members, both of which are deformable and partially conform to the part.

FIGS. 4 and 5 show another embodiment of a tool in accordance with the principles of this invention with a handle having a first and second ring connected thereto which are hinged together and openable by squeezing the handle.

FIG. 6 is a cross sectional view taken along line 6-6 in FIG. 4.

### DETAILED DESCRIPTION OF THE PREFERRED EMBODIMENTS

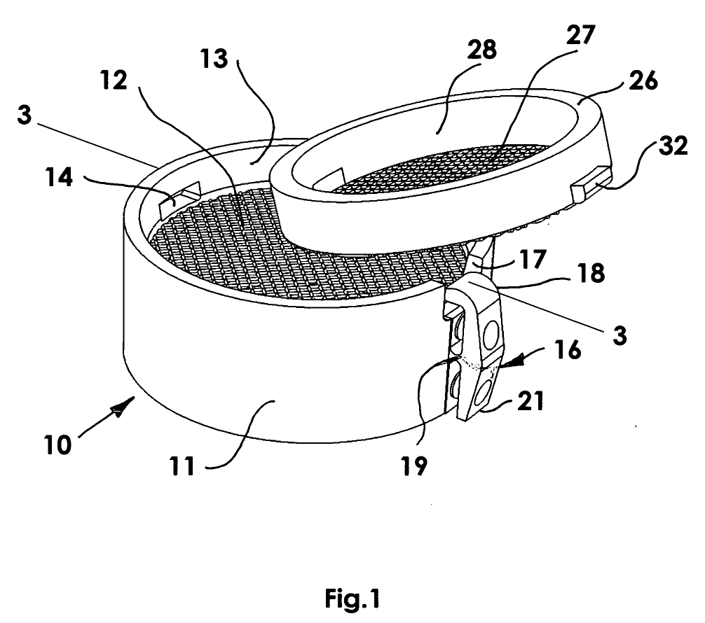

In accordance with the present invention there is shown in FIG. 1 a tool generally designated as 10. The tool 10 has a first or bottom member 11 which has a porous member 12, such as mesh, secured within the inner periphery or rim 13 of the bottom member 11. The porous member 12 is preferably a plastic or metal mesh which is deformable or flexible so that when held over the part it partially conforms to the shape of the part. The bottom member 11 also has at least one opening 14 formed in the periphery 13 above the porous member 12. The bottom member 11 has a latch generally designated as 16 pivotally mounted at 19 to the member 11 opposite the opening 14. The upper portion of the member 11 has a recess 17 formed therein opposite the opening 14. The latch 16 has an upper portion 18 which extends over the recess 17. The latch pivots at 19 when the bottom portion 21 of the latch is depressed. The upper portion 18 moves outwardly from the recess 17 allowing the top member 26 to be installed or removed.

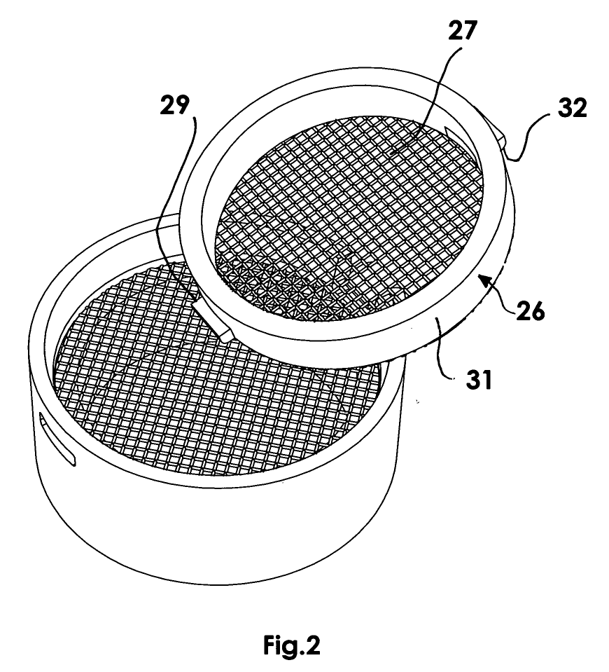

The second or top member 26 has a porous member 27 secured within its inner periphery 28 substantially at the bottom surface of the top member 26. The porous member 27 is preferably a plastic or metal mesh which is deformable or flexible so that when held over the part it partially conforms to the shape of the part. Either one or both of the porous members 12 and 27 may be deformable. The top member 26 has an outer diameter or shape slightly smaller than the inner diameter of the bottom member 11 and has a protrusion 29 formed in or attached to the outer periphery 31 so that it can mate with the opening 14 in member 11. See FIG. 2. The member 26 has another protrusion 32 opposite protrusion 29. Protrusion 32 is adapted to fit within recess 17 of member 11 when members 11 and 26 are placed together. While members 11 and 26 are shown as round, they may be square or any other shape.

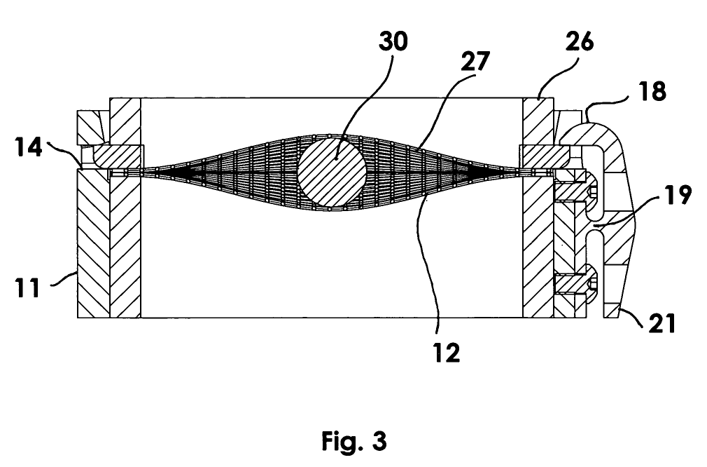

In use, a restoration or other similar small or delicate part 30 (see FIG. 3) is placed on the bottom porous member 12. The top member 26 is tilted so that the protrusion 29 can be inserted into the opening 14 of the bottom member. The bottom portion 21 of the latch 16 is depressed so that the upper portion 18 of the latch pivots outwardly to allow the other protrusion 32 to fit within the recess 17. When the latch is released it moves the upper portion 18 over the protrusion 32 to hold the upper member 26 in place. The porous members 12 and/or 27 have metal or plastic mesh which is flexible and deformable so that the part is substantially immobilized without damage to it when the members 11 and 26 are locked together. FIG. 3 illustrates how the porous members 12 and 27 deform to immobilize the part 30. The cleaning fluid is then sprayed onto the part 30 or the entire assembly is placed into a bath for cleaning.

Alternatively, for parts of larger size, the tool 10 can be designed to leave a predetermined space between the porous members 12 and 27 to accommodate any size part when the top and bottom members are locked together. Such a space may not be necessary if the porous members have sufficient ability to deform. The part is then subjected to fluid cleaning or other treatment. With the part being substantially immobilized between porous members 12 and 27, it will not be damaged, even when subjected to pressure. The tool 10 with the part therein can also be placed in a bath, such as an ultrasonic bath, for cleaning.

While a latch mechanism 16 is shown, it is apparent that many other mechanisms can be used to hold the bottom and top members 11 and 26 secured together in order to substantially immobilize the part therebetween.

Referring to FIG. 3, there is shown a part 30 held between porous members 12 and 28. It shows the deformation of the porous members to conform to and substantially immobilize the part 30.

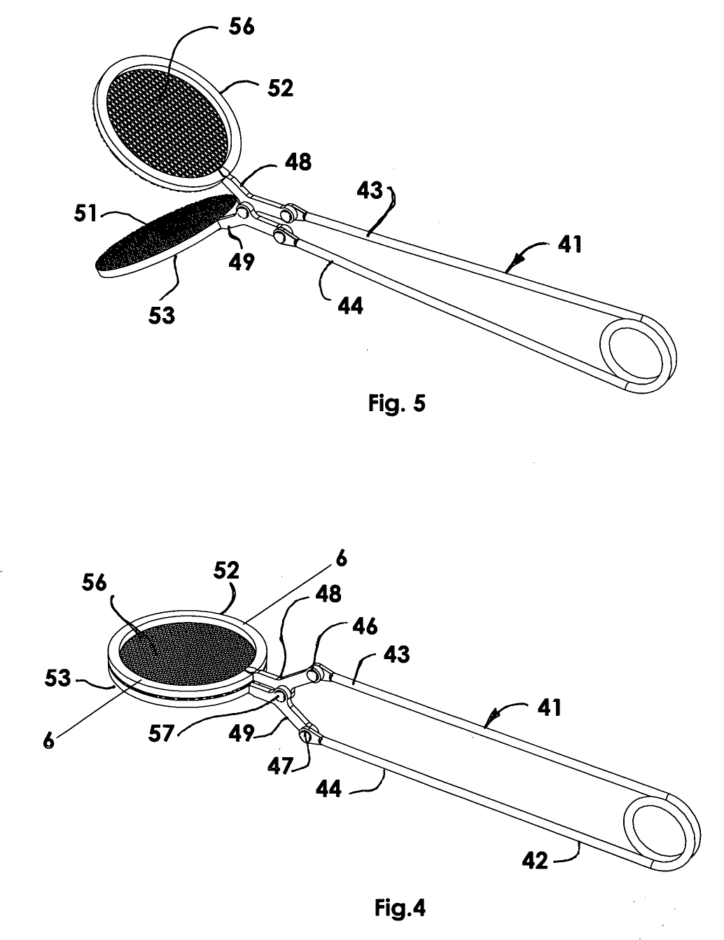

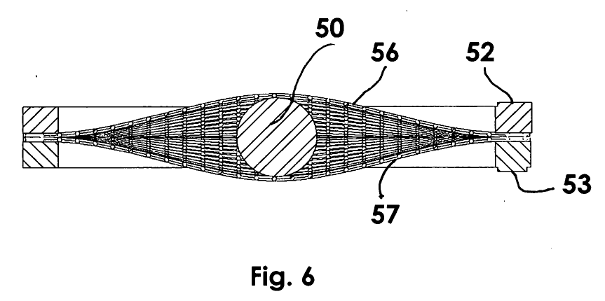

Referring to FIGS. 4 and 5, there is shown another embodiment of a tool generally designated as 41 having a U shaped spring handle 42 having free ends 43 and 44. The free ends 43 and 44 are pivotally connected at 46 and 47 to members 48 and 49 which are hinged together at 51. The other ends of the members 48 and 49 are each connected to a ring 52 and 53 respectively. The rings 52 and 53 each have a porous member 56 and 57 respectively mounted within the ring. One or both of the porous members 56 and 57 is deformable or flexible so that when held over the part it partially conforms to the shape of the part. The rings 52 and 53 need not be circular, but could be square or any other shape. In use, the free ends 43 and 44 of the handle 41 are squeezed together to separate the rings 52 and 53. A part 50 (see FIG. 6), such as a dental restoration, is placed between the porous members 56 and 57 and the handle is released to allow the porous members 56 and 57 to immobilize the part. The porous members 56 and 57 hold the part so that it does not move during cleaning.

Although the present invention has been described in terms of certain preferred embodiments, one skilled in the art will readily appreciate the various modifications that may be made without departing from the spirit and scope of the present invention. It is intended that the present invention be limited solely by the scope of the following claims.

What is claimed is:

1. A tool for holding a small part for cleaning comprising:
a first porous member for receiving a small part for cleaning;
a second porous member positioned over said first member and being deformable to partially conform to the part for substantially immobilizing said part between said first and second members; and
means for holding said first and second members together while a cleaning fluid is directed at said substantially immobilized part.

2. A tool for holding a small part for cleaning as set forth in claim 1 wherein said holding means comprises:
means for securing said first and second members together.

3. A tool for holding a small part for cleaning as set forth in claim 2 wherein said securing means comprises a latch mounted to said first member having an end for engaging and securing said second member when said second member is positioned over said first member.

4. A tool for holding a small part for cleaning as set forth in claim 1 wherein both of said first and second porous members are deformable.

5. A tool for holding a small part for cleaning comprising:
a first ring having a first planar porous member mounted within its periphery;
a second ring having a second planar porous member mounted within its periphery;
at least one of said first or second porous members being deformable; and
means for opening and closing said first and second rings to allow a part to be placed between the first and second porous members so that said part is immobilized therebetween.

5. A tool for holding a small part for cleaning as set forth in claim 5 further comprising:
a U shaped handle having one of its free ends connected to the first ring and the other of its free ends connected to the second ring; and
means for spring biasing the free ends of said handle so that the first and second rings are normally held together.
